(19) United States
(12) Patent Application Publication
(10) Pub. No.: US 2026/0312772 A1
(43) Pub. Date: Oct. 8, 2026

(54) METHOD FOR PROCESSING INFORMATION, COMMUNICATION DEVICE, AND STORAGE MEDIUM

(71) Applicant: Beijing Xiaomi Mobile Software Co., Ltd., Beijing (CN)

(72) Inventor: Yanhua LI, Beijing (CN)

(21) Appl. No.: 18/996,801

(22) PCT Filed: Jul. 22, 2022
(86) PCT No.: PCT/CN2022/107542

§ 371 Date: Jan. 17, 2025

(51) Int. Cl. H04L 5/00

(52) U.S. Cl. CPC H04L 5/0094; H04L 5/0037

(57) ABSTRACT

A method for processing information, includes: determining configuration information of a reference signal on at least one initial bandwidth part (BWP) of first-type user equipment (UE), where the configuration information indicates a configuration of a configuration parameter set, and the configuration parameter set includes a set of at least one information element (IE) configured to indicate a resource set of the reference signal.

### CROSS-REFERENCE TO RELATED APPLICATIONS

The present application is a U.S. National Stage of International Application No. PCT/CN2022/107542, filed on Jul. 22, 2022, the contents of all of which are incorporated herein by reference in their entireties for all purposes.

### BACKGROUND OF THE INVENTION

In current 3GPP standardization of an R17 power-saving project, it is proposed to use an additional tracking reference signal (TRS) or channel state information-reference signal (CSI-RS) in an idle state to assist users in obtaining time-frequency domain synchronization with a network. Compared to original synchronization signal/PBCH block (SSB) synchronization, a TRS or CSI-RS configuration may be configured to be closer to a paging occasion (PO) moment; while an original SSB is far away from a PO location, so that user equipment (UE) needs to wake up a long time in advance to be synchronized with the SSB. After adopting the additional TRS or CSI-RS, the UE may wake up later and thus save more power.

### SUMMARY OF THE INVENTION

The present disclosure relates to the technical field of communications and provides a method for processing information, a communication device, and a storage medium.

According to a first aspect of the present disclosure, a method for processing information is provided. The method is performed by a network device and includes:
determining configuration information of a reference signal on at least one initial bandwidth part (BWP) of first-type UE, where the configuration information indicates a configuration of a configuration parameter set; and the configuration parameter set includes: a set of at least one information element (IE) configured to indicate a resource set of the reference signal.

According to a second aspect of the present disclosure, a method for processing information is provided. The method is performed by first-type UE and includes:
receiving configuration information, where the configuration information is configured to indicate a configuration of a configuration parameter set of a reference signal on at least one BWP of the first-type UE; and the configuration parameter set includes: a set of at least one IE configured to indicate a resource set of the reference signal.

According to a third aspect of the present disclosure, a communication device is provided, including:
one or more processors; and
a memory that stores processor-executable instructions; where
the one or more processors are collectively configured to:
receive configuration information, where the configuration information is configured to indicate a configuration of a configuration parameter set of a reference signal on at least one BWP of the first-type UE; and the configuration parameter set includes: a set of at least one IE configured to indicate a resource set of the reference signal.

It is to be understood that the above general descriptions and later detailed descriptions are merely explanatory and illustrative, and cannot limit the examples of the present disclosure.

### BRIEF DESCRIPTION OF DRAWINGS

FIG. 1 is a schematic structural diagram of a wireless communication system illustrated according to an example.

FIG. 2 is a schematic diagram of a BWP illustrated according to an example.

FIG. 3 is a flow diagram of a method for processing information illustrated according to an example.

FIG. 4 is a flow diagram of a method for processing information illustrated according to an example.

FIG. 5 is a flow diagram of a method for processing information illustrated according to an example.

FIG. 6 is a flow diagram of a method for processing information illustrated according to an example.

FIG. 7 is a flow diagram of a method for processing information illustrated according to an example.

FIG. 8 is a flow diagram of a method for processing information illustrated according to an example.

FIG. 9 is a flow diagram of a method for processing information illustrated according to an example.

FIG. 10 is a flow diagram of a method for processing information illustrated according to an example.

FIG. 11 is a block diagram of a device for processing information illustrated according to an example.

FIG. 12 is a block diagram of a device for processing information illustrated according to an example.

FIG. 13 is a block diagram of UE illustrated according to an example.

FIG. 14 is a block diagram of a base station illustrated according to an example.

### DETAILED DESCRIPTION OF THE INVENTION

Examples will be described in detail here, and instances of the examples are shown in the accompanying drawings. When the following description refers to the accompanying drawings, unless otherwise indicated, the same numbers in different accompanying drawings indicate the same or similar elements. The implementations described in the following examples do not represent all implementations consistent with the examples of the present disclosure. Rather, they are merely instances of devices and methods consistent with some aspects of the examples of the present disclosure as detailed in the appended claims.

The terms used in the examples of the present disclosure are merely for the purpose of describing specific examples, and are not intended to limit the examples of the present disclosure. The singular forms “one” and “the” used in the examples of the present disclosure and the appended claims are also intended to include the majority forms unless the context clearly indicates other meanings. It is also to be understood that the term “and/or” used here refers to and contains any or all possible combinations of one or more associated listed items.

It is to be understood that although the terms first, second, third, etc. may be configured to describe various information in the examples of the present disclosure, such information is not limited to these terms. These terms are merely configured to distinguish the same type of information from each other. For example, without departing from the scope of the examples of the present disclosure, first information may also be referred to as second information, and similarly, the second information may also be referred to as the first information. Depending on the context, the word “if” as used here may be interpreted as “at the time” or “when” or “in response to determining”.

In the related art, a new type of user equipment (UE) has been introduced; and this new type of UE is either reduced capability (RedCap) UE or 5G NR-lite UE. This new type of UE is similar to an internet-of-things device and typically meets at least one of the following requirements: (1) a low manufacturing cost and low complexity; (2) enhanced coverage to a certain extent; (3) power saving; (4) part of UE supporting a one-RX-antenna structure or part of UE supporting a dual-RX-antenna structure; or (5) in R18, the introduction of the new type of UE further reduces an applicable bandwidth of the new type of UE.

For the new type of UE of R18, more SSBs may be desired for performing synchronization; and thus, for this new type of UE, the use of the TRS or the CSI-RS is more critical. However, due to the bandwidth limitations of the new type of UE, it may lead to situations where a TRS or CSI-RS configured for an enhanced mobile broadband (eMBB) may not be suitable for the new type of UE; and thus, how to configure the TRS or the CSI-RS of this new type of UE will become a problem.

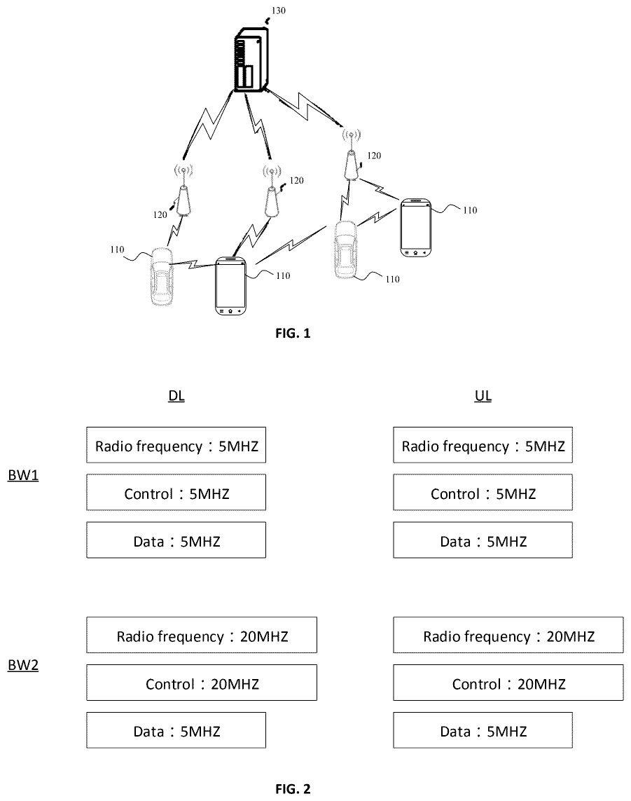

Referring to FIG. 1, it shows a schematic structural diagram of a wireless communication system provided by an example of the present disclosure. As shown in FIG. 1, the wireless communication system is a communication system based on a cellular mobile communication technology. The wireless communication system may include: a plurality of pieces of user equipment 110 and a plurality of base stations 120.

The user equipment 110 may refer to devices that provide a user with speech and/or data connectivity. The user equipment 110 may communicate with one or more core networks via a radio access network (RAN). The user equipment 110 may be internet of things user equipment, such as a sensor device, a mobile phone (or referred to as a “cellular” phone) and a computer with internet of things user equipment. For example, the user equipment 110 may be fixed, portable, pocket-size, handheld, computer built-in or vehicle-mounted devices. For example, the user equipment 110 may be a station (STA), a subscriber unit, a subscriber station, a mobile station, a mobile, a remote station, an access point, a remote terminal, an access terminal, a user terminal, a user agent, a user device, or user equipment. Or, the user equipment 110 may also be an unmanned aircraft device. Or, the user equipment 110 may also be a vehicle-mounted device, such as a trip computer with a wireless communication function, or wireless user equipment connected with an external trip computer. Or, the user equipment 110 may also be a roadside device, such as a street lamp, a signal light or other roadside devices with wireless communication functions.

The base stations 120 may be a network side device in the wireless communication system. The wireless communication system may be a 4th generation mobile communication (4G) system, also referred to as a long term evolution (LTE) system; or, the wireless communication system may also be a 5G system, also referred to as a new radio system or a 5G NR system. Or, the wireless communication system may also be a next-generation system of the 5G system. An access network in the 5G system may be referred to as a new generation-radio access network (NG-RAN).

The base stations 120 may be evolved base stations (eNB) adopted in the 4G system. Or, the base stations 120 may also be base stations adopting centralized and distributed architectures (gNB) in the 5G system. When the base stations 120 adopt the centralized and distributed architectures, they typically each include a central unit (CU) and at least two distributed units (DU). Protocol stacks of a packet data convergence protocol (PDCP) layer, a radio link control (RLC) layer and a medium access control (MAC) layer are disposed in the central unit; and protocol stacks of physical (PHY) layers are disposed in the distributed units, and specific implementations of the base stations 120 are not limited in the examples of the present disclosure.

The base stations 120 and the user equipment 110 may establish wireless connection through wireless radio. In different implementations, the wireless radio is a wireless radio based on the 4G standard; or, the wireless radio is a wireless radio based on the 5G standard, such as new radio; or, the wireless radio may also be a wireless radio based on the next-generation mobile communication standard of 5G.

In some examples, the user equipment 110 may also establish an end to end (E2E) connection. For example, the E2E connection is vehicle to vehicle (V2V) communication, vehicle to infrastructure (V2I) communication and vehicle to pedestrian (V2P) communication in vehicle to everything (V2X) communication and other scenarios.

Here, the above user equipment 110 may be considered as a terminal device in following examples.

In some examples, the above wireless communication system may further contain a network management device 130.

The plurality of base stations 120 are connected with the network management device 130. The network management device 130 may be a core network device in the wireless communication system, for example, the network management device 130 may be a mobility management entity (MME) in an evolved packet core (EPC). Or, the network management device 130 may also be other core network devices, such as a serving gateway (SGW), a public data network gateway (PGW), a policy and charging rules function (PCRF) or a home subscriber server (HSS). The implementation form of the network management device 130 is not limited in the examples of the present disclosure.

In order to facilitate the understanding of those skilled in the art, multiple implementations are listed in the examples of the present disclosure to clearly illustrate the technical solution of the examples of the present disclosure. Certainly, those skilled in the art can understand that the multiple examples provided by the examples of the present disclosure can be performed separately, performed after being combined with methods of other examples in the examples of the present disclosure, or performed with some methods in other related technologies after being performed separately or in combination, which is not limited in the examples of the present disclosure.

In order to better understand the technical solution described in any of the examples of the present disclosure, first, a partial explanation of the related technologies will be provided:

In one example, with respect to configuration information of a TRS or a CSI-RS, radio resource control (RRC) unconnected UE may be notified by broadcasting a system information block (SIB17), and an availability indication of the configuration information may be transmitted through a PEI or paging DCI. For example, with respect to the configuration information of the TRS or the CSI-RS, at least one of a time domain resource, a sequence, a cycle, offset or a quasi co location (QCL) parameter may be provided:

-- ASN1START
-- TAG-SIB17-START

| | |
|---|---|
| SIB17-r17 ::= | SEQUENCE { |
| segmentNumber-r17 | INTEGER (0.. 63), |
| segmentType-r17 | ENUMERATED {notLastSegment, lastSegment}, |
| segmentContainer-r17 | OCTET STRING |

}

| | |
|---|---|
| SIB17-r17-IEs ::= | SEQUENCE { |
| trs-ResourceSetConfig-r17 | SEQUENCE (SIZE (1..maxNrofTRS-ResourceSets-r17)) |

OF TRS-ResourceSet-r17,

| | |
|---|---|
| validityDuration-r17 | ENUMERATED {t1, t2, t4, t8, t16, t32, t64, t128, t256, |

t512, infinity, spare5, spare4, spare3, spare2,

spare1}

OPTIONAL, -- Need S

| | | |
|---|---|---|
| lateNonCriticalExtension | OCTET | STRING |

OPTIONAL,
...
}

| | |
|---|---|
| TRS-ResourceSet-r17 ::= | SEQUENCE { |
| powerControlOffsetSS-r17 | ENUMERATED {db−3, db0, db3, db6}, |
| scramblingID-Info-r17 | CHOICE { |
| scramblingIDforCommon-r17 | ScramblingId, |
| scramblingIDperResourceListWith2-r17 | SEQUENCE (SIZE (2)) OF ScramblingId, |
| scramblingIDperResourceListWith4-r17 | SEQUENCE (SIZE (4)) OF ScramblingId, |

```
  ...
  },
```

| | |
|---|---|
| firstOFDMSymbolInTimeDomain-r17 | INTEGER (0..9), |

| | |
|---|---|
| startingRB-r17 | INTEGER |

(0..maxNrofPhysicalResourceBlocks−1),

| | |
|---|---|
| nrofRBs-r17 | INTEGER |

(24..maxNrofPhysicalResourceBlocksPlus1),

| | |
|---|---|
| ssb-Index-r17 | SSB-Index, |
| periodicityAndOffset-r17 | CHOICE { |
| slots10 | INTEGER (0..9), |
| slots20 | INTEGER (0..19), |
| slots40 | INTEGER (0..39), |
| slots80 | INTEGER (0..79) |

},

| | |
|---|---|
| frequencyDomainAllocation-r17 | BIT STRING (SIZE (4)), |
| indBitID-r17 | INTEGER (0..5), |
| nrofResources-r17 | ENUMERATED {n2, n4} |

}
-- TAG-SIB17-STOP
-- ASN1STOP

In one example, an applicable bandwidth for RedCap UE or NR-lite UE is further reduced, namely being further enhanced. For example, as shown in FIG. 2, the applicable bandwidth is reduced from 20 MHz to 5 MHz. For instance, for a bandwidth (BW) BW1, BW1 corresponding to radio frequency (RF), control and data in downlink (DL) transmission and/or uplink (UL) transmission may be 5 MHz. For another instance, as shown in BW2, a bandwidth corresponding to radio frequency (RF) and control in downlink (DL) transmission and/or uplink (UL) transmission may be 20 MHz, and a bandwidth corresponding to data in downlink (DL) transmission and/or uplink (UL) transmission may be 5 MHz.

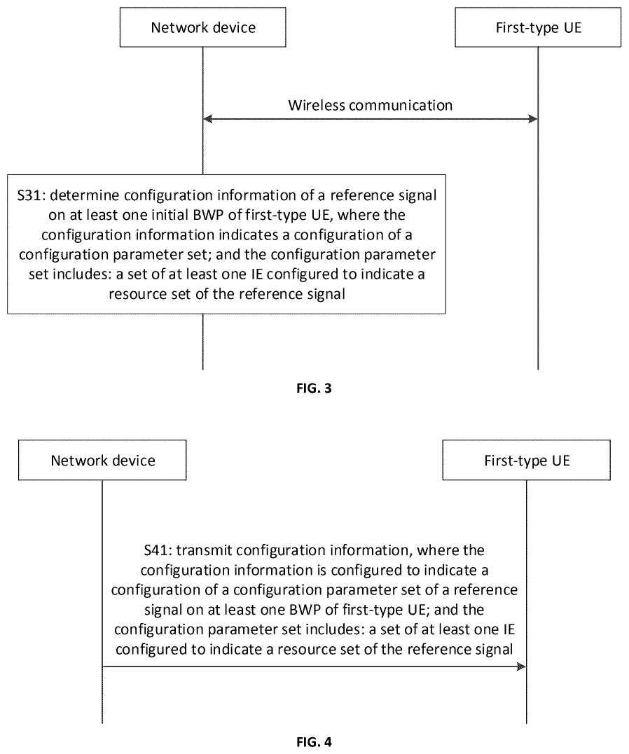

As shown in FIG. 3, an example of the present disclosure provides a method for processing information, which is performed by a network device and includes:
step S31: configuration information of a reference signal on at least one initial BWP of first-type UE is determined, where the configuration information indicates a configuration of a configuration parameter set; and the configuration parameter set includes: a set of at least one IE configured to indicate a resource set of the reference signal.

In one example, the first-type UE may be, but is not limited to, various terminals with reduced capabilities. For instance, the first-type UE may be R18 RedCap UE, or enhanced Redcap UE or R18 5G NR-lite UE, etc.

In another example, the first-type UE may be RRC unconnected UE, and the RRC unconnected UE may be RRC non-idle UE and/or RRC inactive UE. Here, the configuration information is used by the RRC unconnected UE.

In one example, the network device includes an access network device and/or a core network device. Here, the access network device may be, but is not limited to, a base station, and the core network device may be, but is not limited to, various network functions or entities implementing the network functions. Here, the base station may be, but is not limited to, at least one of: a 3G base station, a 4G base station, a 5G base station or other evolved base stations.

In one example, the initial BWP is a downlink initial BWP.

In some examples, the reference signal includes at least one of: a TRS or a CSI-RS.

In some examples, the configuration parameter set includes, but is not limited to, at least one of:
a first configuration parameter set, supporting sharing by a plurality of initial BWPs; or
a second configuration parameter set, supporting use by a single initial BWP.

Here, a first configuration parameter may be shared by reference signals on the plurality of initial BWPs, while a second configuration parameter may be a reference signal on the single initial BWP. Here, the reference signal includes a TRS and/or a CIS-RS.

In one example, IEs in the first configuration parameter set include at least one of:
an indication information duration (validityDuration);
power control offset (powerControlOffsetSS); or
at least one IE in a TRS resource set.

Here, the indication information duration (validityDuration) is configured to indicate an availability duration of the configuration information or the first configuration parameter set.

In one example, all configuration parameters of the TRS belong to the second configuration parameter set, that is, the first configuration parameter set does not exist.

In one example, IEs in the second configuration parameter set include at least one of:
a starting resource block (startingRB);
the number of resource blocks (nrofRBs); or
at least one IE in a TRS resource set.

Here, the TRS resource set may be: TRS-ResourceSet-r17, or, the TRS resource set may be any implementable TRS resource set or a newly-defined TRS resource set. Here, TRS-ResourceSet-r17 may be split into a first configuration parameter set and a second configuration parameter set.

In one example, the TRS resource set includes IEs of at least one of: power control offset (powerControlOffsetSS), a first OFDM symbol in a time domain (firstOFDMSymbolInTimeDomain), a starting resource block (startingRB), the number of resource blocks (nrofRBs), a synchronization signal index (ssb-Index), a periodicity and offset (periodicityAndOffset), frequency domain resource position allocation (frequencyDomainAllocation), an indicating bit identification (indBitID), or the number of resources (nrofResources).

Here, the resource set may be a set of one or more IEs in any above example. In the example of the present disclosure, “a plurality of” may be two or more.

Certainly, in other examples, the first configuration parameter set may be a set of any one or more of the above IEs; and/or, the second configuration parameter set may be a set of any one or more of the above IEs.

In the example of the present disclosure, the network device determines the configuration information of the reference signal on at least one initial BWP of the first-type UE, where the configuration information indicates the configuration of the configuration parameter set; the configuration parameter set includes: the set of at least one IE configured to indicate the resource set of the reference signal; and thus, the network device may configure the configuration parameter set for the reference signal on the at least one initial BWP of the first-type UE, such that the first-type UE may use the reference signal based on the appropriate configuration parameter set.

Also, the network device may configure the configuration information of the configuration parameter set including at least one IE for the reference signal on the at least one initial BWP of the first-type UE, and when the configuration parameter set is a set of a plurality of IEs, the number of bits occupied by the configuration may further be reduced, and thus a signaling overhead is reduced. In some examples, a number of bits of at least part of IEs in the configuration parameter set of the first-type UE is different from a number of bits of corresponding IEs in a configuration parameter set of second-type UE.

Here, power consumption of the first-type UE is less than or equal to power consumption of the second-type UE; and/or, a maximum bandwidth supported by the initial BWP of the first-type UE is less than or equal to a maximum bandwidth supported by an initial BWP of the second-type UE; and/or, a structure of the first-type UE is simpler than a structure of the second-type UE. For instance, the first-type UE may be R18 RedCap UE, and the second-type UE may be R17 RedCap UE. For another instance, the first-type UE may be R18 RedCap UE, and the second-type UE may be traditional UE, e.g., the second-type UE may be a computer, a mobile device, a server or a multimedia device, etc.

For example, the maximum bandwidth supported by the initial BWP of the first-type UE is 5 MHz, and the maximum bandwidth supported by the initial BWP of the second-type UE is 20 MHz. The first configuration parameter set is configured for the plurality of initial BWPs of the first-type UE, and the IEs included in the first configuration parameter set of the first-type UE may be a first power control offset. The first configuration parameter set is configured for the plurality of initial BWPs of the second-type UE, and the IEs included in the first configuration parameter set of the second-type UE may be a second power control offset. The first power control offset is a first number of bits, and the second power control offset is a second number of bits, where the first number of bits is smaller than the second number of bits. For instance, the first number of bits is 4, and the second number of bits is 6.

For example, the second configuration parameter set is configured for a first initial BWP in the initial BWPs of the first-type UE, and the IEs included in the second configuration parameter set of the first-type UE may be a first number of resource blocks. The second configuration parameter set is configured for a first initial BWP in the initial BWPs of the second-type UE, and the IEs included in the second configuration parameter set of the second-type UE may be a second number of resource blocks. The first number of resource blocks is a third number of bits, and the second number of resource blocks is a fourth number of bits, where the third number of bits is smaller than the fourth number of bits. For instance, the third number of bits is 4, and the fourth number of bits is 8.

In the example of the present disclosure, since the maximum bandwidth supported by the initial BWP of the first-type UE is different from the maximum bandwidth supported by the initial BWP of the second-type UE, the number of bits of at least part of the IEs in the configuration parameter set of the initial BWP of the first-type UE and the number of bits of IEs corresponding to the corresponding initial BWP of the second-type UE may be configured differently, and thus the configurations of the first-type UE and the second-type UE for different number of bits of the same IE may be distinguished.

It is to be noted that, those skilled in the art can understand that the method provided by the example of the present disclosure can be performed separately, or performed with some methods in the example of the present disclosure or some methods in the related art.

As shown in FIG. 4, an example of the present disclosure provides a method for processing information, which is performed by a network device and includes:
step S41: configuration information is transmitted, where the configuration information is configured to indicate a configuration of a configuration parameter set of a reference signal on at least one BWP of first-type UE; and the configuration parameter set includes: a set of at least one IE configured to indicate a resource set of the reference signal.

In some examples of the present disclosure, the configuration information may be the configuration information in step S31; the reference signal may be the reference signal in step S31; and the configuration parameter set, the resource set and the IE may be the configuration parameter set, the resource set and the IE in step S31.

For example, the reference signal includes at least one of: a TRS or a CSI-RS.

For example, the configuration parameter set includes, but is not limited to, at least one of:
a first configuration parameter set, supporting sharing by a plurality of initial BWPs; or
a second configuration parameter set, supporting use by a single initial BWP.

Here, step S41 that the configuration information is transmitted may be: the configuration information is transmitted to the first-type UE by the network device. Here, if the network device is a base station, the configuration information may be transmitted to the first-type UE by the base station; or, if the network device is a core network device, the configuration information is transmitted to the base station by the core network device, and the configuration information is forwarded to the first-type UE by a base station.

As such, in the example of the present disclosure, the configuration information is transmitted to the first-type UE by the network device, such that the first configuration parameter set and/or the second configuration parameter set may be configured for a reference signal on at least one initial BWP of the first-type UE.

In the example of the present disclosure, the configuration information is transmitted to the UE by the network device, and the UE may be informed of the configuration of the configuration parameter set of the reference signal on the at least one initial BWP. Besides, since a combinational configuration may be issued for a public IE in the resource set in the example of the present disclosure, for instance, the same first configuration parameter set may be issued for the plurality of initial BWPs, the number of bits where the configuration information is located may further be reduced, and thus the overhead of a message carrying the configuration information is reduced. Alternatively, since the second parameter set may be configured for the single initial BWP in the example of the present disclosure, a corresponding second configuration parameter set may be configured for each initial BWP, and thus individualized configurations of the plurality of initial BWPs may be achieved, and configuration requirements of respective initial BWPs are met.

In some examples, step S41 that the configuration information is transmitted includes: a first-type message is transmitted, where the first-type message carries configuration information indicating configuring the first configuration parameter set.

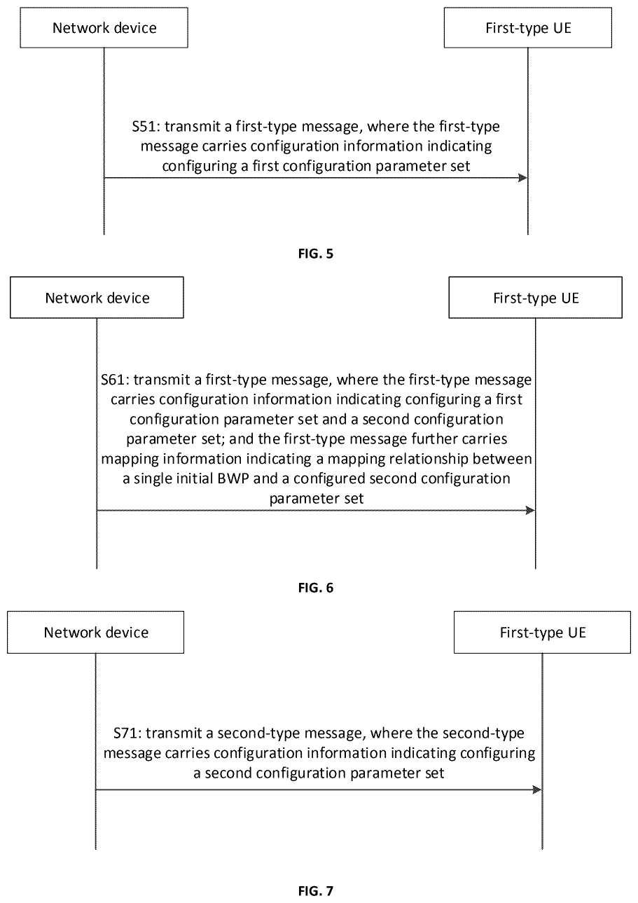

As shown in FIG. 5, an example of the present disclosure provides a method for processing information, which is performed by a network device and includes:
step S51: a first-type message is transmitted, where the first-type message carries configuration information indicating configuring a first configuration parameter set.

In the example of the present disclosure, the first configuration parameter set may be the first configuration parameter set in above examples.

In one example, the first-type message includes a system message. Here, the system message may be any system information block, which may be, but is not limited to, SIB1, SIB2, SIB11 or SIB12.

In another example, the first-type message includes a system information block. Here, the system information block may be, but is not limited to, SIB17 or SIBX.

As such, in the example of the present disclosure, the first configuration parameter set may be transmitted through the first-type message, such as the system information block, that is, a shared first configuration parameter set may be transmitted to a plurality of initial BWPs, and thus the bit overhead of the system information block carrying the configuration information may be reduced.

In some examples, step S41 that the configuration information is transmitted includes: a first-type message is transmitted, where the first-type message carries configuration information indicating configuring the first configuration parameter set and a second configuration parameter set; and the first-type message further carries mapping information indicating a mapping relationship between a single initial BWP and a configured second configuration parameter set.

As shown in FIG. 6, an example of the present disclosure provides a method for processing information, which is performed by a network device and includes:
step S61: a first-type message is transmitted, where the first-type message carries configuration information indicating configuring a first configuration parameter set and a second configuration parameter set; and the first-type message further carries mapping information indicating a mapping relationship between a single initial BWP and a configured second configuration parameter set.

In the example of the present disclosure, the first configuration parameter set and the second configuration parameter set may be the first configuration parameter set and the second configuration parameter set in above examples respectively.

In one example, the mapping information may be carried in the first-type message, but not carried in the configuration information. In another example, the mapping information may be carried in the configuration information.

For example, an initial BWP of first-type UE includes a first initial BWP and a second initial BWP. The first-type message is transmitted by the network device, and the first-type message includes the configuration information. The configuration information indicates the first initial BWP and the second initial BWP to be configured with the first configuration parameter set. The configuration information further includes the mapping information, and the mapping information indicates a mapping relationship between the first initial BWP and a second configuration parameter set 1 and indicates a mapping relationship between the second initial BWP and a second configuration parameter set 2.

For example, IEs of the first configuration parameter set include an indication information duration or at least part of IEs in a TRS resource set, and IEs of the second configuration parameter set include at least one IE in the TRS resource set that is not IEs in the first configuration parameter set.

For example, the IEs of the first configuration parameter set include the indication information duration, and the IEs of the second configuration parameter set include at least one IE in the TRS resource set.

In some examples of the present disclosure, the TRS resource set may be the TRS resource set in above examples.

In the example of the present disclosure, both the first configuration parameter set and the second configuration parameter set may be broadcast in the first-type message (such as the system information block), and thus the two types of configuration parameter sets may be transmitted through one kind of message, such as the system information block. Besides, since the shared first configuration parameter set may be configured for a plurality of initial BWPs, the signaling overhead of the first-type message, such as the system information block, may be reduced.

Moreover, in the example of the present disclosure, in a case where the first-type message carries the configuration of the second configuration parameter set, the first-type message further includes the mapping information indicating the mapping relationship between the single initial BWP and the configured second configuration parameter set, and thus the first-type UE may be enabled to accurately know which second configuration parameter set is configured on which BWP.

In some examples, step S41 that the configuration information is transmitted includes: a second-type message is transmitted, where the second-type message carries configuration information indicating configuring the second configuration parameter set.

Here, the second-type message further carries the mapping information indicating the mapping relationship between the single initial BWP and the configured second configuration parameter set.

As shown in FIG. 7, an example of the present disclosure provides a method for processing information, which is performed by a network device and includes:
step S71: a second-type message is transmitted, where the second-type message carries configuration information indicating configuring a second configuration parameter set.

In the example of the present disclosure, the second configuration parameter set may be the second configuration parameter set in above examples.

In one example, the second-type message includes: a PDCCH configuration message.

In the example of the present disclosure, the configuration information including the second configuration parameter set may be transmitted through the second-type message, such as the PDCCH configuration message, and thus another way of transmitting the configuration information of the second configuration parameter set may be provided, which may adapt to more application scenarios. Besides, the PDCCH configuration message carrying the configuration information indicating the second configuration parameter set is transmitted, so that the PDCCH configuration message may achieve two functions: a relevant configuration of an original PDCCH and a configuration of the second parameter set, and thus the utilization rate of the PDCCH configuration message may be increased, and the signaling overhead may be saved.

In some examples of the present disclosure, if a second configuration parameter set of a single initial BWP is transmitted in a first-type message and the second-type message, then the second configuration parameter set of the single initial BWP carried in the second-type message covers the second configuration parameter set of the single initial BWP carried in the first-type message. At the moment, first-type UE determines that the second configuration parameter set for the single initial BWP in the second-type message is valid.

In some examples of the present disclosure, if the second configuration parameter set of the single initial BWP is in the first-type message and the second configuration parameter set of the single initial BWP is configured in the second-type message but not issued, then the second configuration parameter set of the single initial BWP carried in the first-type message is valid.

It is to be noted that, those skilled in the art can understand that the method provided by the example of the present disclosure can be performed separately, or performed with some methods in the example of the present disclosure or some methods in the related art.

In some examples, step S41 that the configuration information is transmitted includes: a system information block is transmitted, where different segments of the system information block carry configuration information indicating configuration parameter sets configured on different initial BWPs.

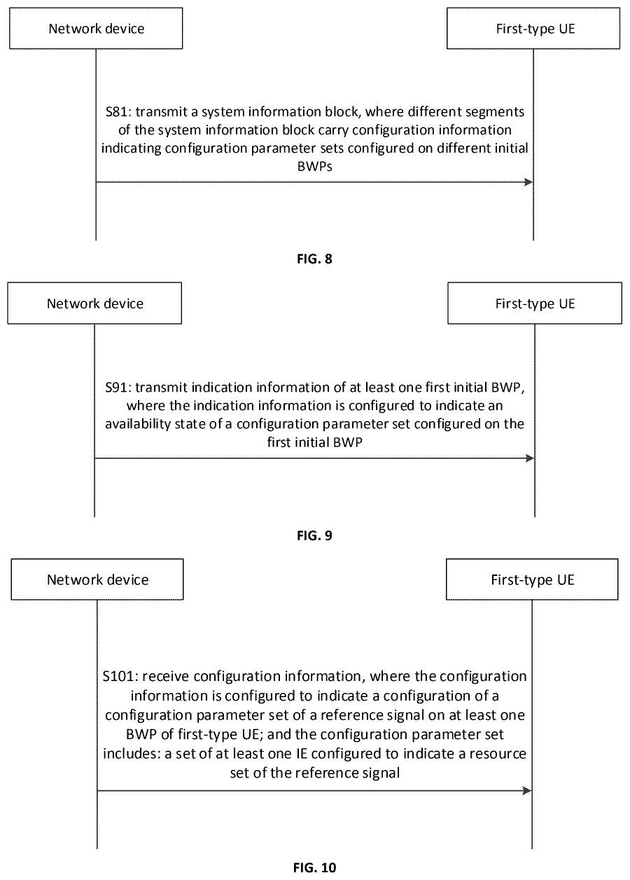

As shown in FIG. 8, an example of the present disclosure provides a method for processing information, which is performed by a network device and includes:
step S81: a system information block is transmitted, where different segments of the system information block carry configuration information indicating configuration parameter sets configured on different initial BWPs.

Here, the system information block may be divided into at least one segment. For instance, the system information block is divided into a plurality of segments, and each segment may carry configuration information of different configuration parameter sets. Here, one segment of the system information block may include one or more information elements (IEs) of a system message.

For example, the initial BWPs include: a first initial BWP and a second initial BWP, where a first segment of the system information block carries configuration information of a first configuration parameter set and/or a second configuration parameter set configured on the first initial BWP, and a second segment of the system information block carries configuration information of a second configuration parameter set configured on the second initial BWP.

For example, initial BWPs of the first-type UE determined by the network device includes a plurality of initial BWPs, and the plurality of initial BWPs at least include a first initial BWP and a second initial BWP. SIB-X is transmitted by the network device, where the SIB-X carries configuration information of first configuration parameter sets on the plurality of initial BWPs as well as second configuration parameter sets on different initial BWPs. For instance, a first segment of the SIB-X carries configuration information of the first configuration parameter sets configured for the plurality of initial BWPs as well as the second configuration parameter set of the first initial BWP, and a second segment of the SIB-X carries configuration information of the second configuration parameter set of the second initial BWP.

As such, in the example of the present disclosure, the configuration information of the configuration parameter sets of the different initial BWPs may be configured in different segments of the system information block, such that first-type UE may obtain corresponding segments of the system information block based on initial BWPs that need to be monitored, and thus the overhead of signaling interactions and the like may be further reduced, and then the purposes of power saving and/or power consumption lowering are achieved.

It is to be noted that, those skilled in the art can understand that the method provided by the example of the present disclosure can be performed separately, or performed with some methods in the example of the present disclosure or some methods in the related art.

In some examples, the initial BWPs include: a first initial BWP.

The method further includes: indication information of at least one first initial BWP is transmitted, where the indication information is configured to indicate an availability state of a configuration parameter set configured on the first initial BWP.

As shown in FIG. 9, an example of the present disclosure provides a method for processing information, which is performed by a network device and includes:
step S91: indication information of at least one first initial BWP is transmitted, where the indication information is configured to indicate an availability state of a configuration parameter set configured on the first initial BWP.

In some examples of the present disclosure, the configuration parameter set may be the configuration parameter set in step S31. For example, the configuration parameter set includes, but is not limited to, at least one of: a first configuration parameter set, supporting sharing by a plurality of initial BWPs; or a second configuration parameter set, supporting use by a single initial BWP.

In one example, the availability state includes at least one of: an available state; or an unavailable state.

In another example, the availability state includes: transformation from the available state to the unavailable state; and transformation from the unavailable state to the available state.

As such, in the example of the present disclosure, the indication information may be configured to indicate whether the configuration parameter set configured on the at least one initial BWP is available or unavailable.

In some examples, step S91 that the indication information of the at least one first initial BWP is transmitted includes at least one of:
transmitting a PEI of the first initial BWP, where the PEI includes the indication information; or
transmitting paging DCI of the first initial BWP, where the paging DCI includes the indication information.

An example of the present disclosure provides a method for processing information, which is performed by a network device and includes: a PEI of a first initial BWP is transmitted, where the PEI includes indication information; and/or, paging DCI of the first initial BWP is transmitted, where the paging DCI includes the indication information.

As such, in the example of the present disclosure, the indication information may be transmitted to at least one piece of first-type UE in advance through the PEI or the paging DCI or the like, such that the first-type UE may know whether a configuration parameter set of a reference signal on the initial BWP is available, and thus the precision of a configuration of a reference signal on at least one initial BWP may be accurately obtained, and then the situation that the precision of synchronous monitoring is lowered due to the use of a wrong configuration parameter set may be reduced.

In some examples, the initial BWP further includes: a second initial BWP. The indication information is further configured to indicate an availability state of a configuration parameter set configured on the second initial BWP.

An example of the present disclosure provides a method for processing information, which is performed by a network device and includes: indication information of at least one first initial BWP is transmitted, where the indication information is configured to indicate an availability state of a configuration parameter set configured on the first initial BWP and an availability state of a configuration parameter set configured on a second initial BWP.

As such, in the example of the present disclosure, the indication information, such as a PEI or paging DCI, on the first initial BWP may be configured to indicate availability states of second configuration parameter sets on other initial BWPs (such as the second initial BWP) of first-type UE, and thus whether a reference signal on the second initial BWP of the first-type UE is available or not may be informed additionally. Besides, if the first-type UE needs to use other initial BWPs, such as the second initial BWP, whether the first-type UE may use the second initial BWP may be accurately determined based on the indication information on the first initial BWP.

In some examples of the present disclosure, if the first-type UE determines that the configuration parameter set configured on the first initial BWP is in an unavailable state based on the indication information, the first-type UE may fall back to an SSB synchronization mode for performing synchronization. Here, the first initial BWP is a BWP which is currently activated by the first-type UE. Here, if a TRS resource or a resource set is not configured on the first initial BWP, it may also be considered that the configuration parameter set configured on the first initial BWP is unavailable, and at the moment, the first-type UE may fall back to the SSB synchronization mode for performing synchronization.

In some examples of the present disclosure, if the first-type UE determines that the configuration parameter set configured on the first initial BWP is in an unavailable state and the configuration parameter set configured on the second initial BWP is in an available state based on the indication information, the first-type UE first hops to the second initial BWP having the reference signal for performing synchronization or measurement, and then returns to an originally-used first initial BWP. Here, the first-type UE first hops to the second initial BWP having the reference signal for performing synchronization or measurement, and then returns to the originally-used first initial BWP, and this process may be that: the first-type UE is frequency-modulated to the second BWP. Here, if activation situations of TRSs on different initial BWPs are different (different in availability state), the first-type UE needs to hop to other initial BWPs if it is to use TRSs of other initial BWPs other than the currently-activated BWP.

It is to be noted that, those skilled in the art can understand that the method provided by the example of the present disclosure can be performed separately, or performed with some methods in the example of the present disclosure or some methods in the related art.

A method for processing information below is performed by first-type UE and similar to the description of the above information processing method performed by the network device. As for technical details which are not disclosed in the example of the information processing method performed by the first-type UE, please refer to the description of an initial BWP method instance performed by the network device, which is not detailed here.

As shown in FIG. 10, an example of the present disclosure provides a method for processing information, which is performed by first-type UE and includes:
step S101: configuration information is received, where the configuration information is configured to indicate a configuration of a configuration parameter set of a reference signal on at least one BWP of the first-type UE; and the configuration parameter set includes: a set of at least one IE configured to indicate a resource set of the reference signal.

In some examples of the present disclosure, the first-type UE may be the second-type UE in above examples. For example, the first-type UE may be R18 RedCap UE, or enhanced Redcap UE or R18 5G NR-lite UE, etc.

Here, step S101 that the configuration information is received may be: the configuration information transmitted by the first-type UE is received.

In some examples of the present disclosure, the configuration information may be the configuration information in step S31; the configuration parameter set, the resource set and the IE may be the configuration parameter set, the resource set and the IE in step S31; and the reference signal may be the reference signal in step S31.

For example, the reference signal includes at least one of: a TRS or a CSI-RS.

For example, the configuration parameter set includes, but is not limited to, at least one of:
a first configuration parameter set, supporting sharing by a plurality of initial BWPs; or
a second configuration parameter set, supporting use by a single initial BWP.

In one example, IEs in the first configuration parameter set include at least one of:
an indication information duration (validityDuration);
power control offset (powerControlOffsetSS); or
at least one IE in a TRS resource set.

Here, the indication information duration (validityDuration) is configured to indicate an availability duration of the configuration information or the first configuration parameter set.

As an example, the first configuration parameter set may be a null set. That is, only the second configuration parameter set is configured for a terminal. That is, only an individual configuration for a certain BWP exists.

In one example, IEs in the second configuration parameter set include at least one of:
a starting resource block (startingRB);
the number of resource blocks (nrofRBs); or
at least one IE in a TRS resource set.

Here, the TRS resource set may be: TRS-ResourceSet-r17, or, the TRS resource set may be any implementable TRS resource set or a newly-defined TRS resource set. Here, TRS-ResourceSet-r17 may be split into a first configuration parameter set and a second configuration parameter set.

In one example, the TRS resource set includes IEs of at least one of: power control offset (powerControlOffsetSS), a first OFDM symbol in a time domain (firstOFDMSymbolInTimeDomain), a starting resource block (startingRB), the number of resource blocks (nrofRBs), a synchronization signal index (ssb-Index), a periodicity and offset (periodicityAndOffset), frequency domain resource position allocation (frequencyDomainAllocation), an indicating bit identification (indBitID), or the number of resources (nrofResources).

Here, the resource set may be a set of one or more IEs in any above example.

In some examples, a number of bits of at least part of IEs in the configuration parameter set of the first-type UE is different from a number of bits of corresponding IEs in a configuration parameter set of second-type UE.

In some examples, a value range of at least part of IEs in the configuration parameter set of the first-type UE is different from a value range of corresponding IEs in the configuration parameter set of the second-type UE.

In some examples of the present disclosure, the first-type UE and the second-type UE may be the first-type UE and the second-type UE in above examples respectively. For instance, the first-type UE may be R18 RedCap UE, and the second-type UE may be R17 RedCap UE. For another instance, the first-type UE may be R18 RedCap UE, and the second-type UE may be traditional UE, e.g., the second-type UE may be a computer, a mobile device, a server or a multimedia device, etc.

In some examples, step S101 that the configuration information is received includes: a first-type message is received, where the first-type message carries configuration information indicating configuring the first configuration parameter set.

An example of the present disclosure provides a method for processing information, which is performed by first-type UE and includes: a first-type message is received, where the first-type message carries configuration information indicating configuring a first configuration parameter set.

In some examples, step S101 that the configuration information is received includes: a first-type message is received, where the first-type message carries configuration information indicating configuring the first configuration parameter set and a second configuration parameter set; and the first-type message further carries mapping information indicating a mapping relationship between a single initial BWP and a configured second configuration parameter set.

An example of the present disclosure provides a method for processing information, which is performed by first-type UE and includes: a first-type message is received, where the first-type message carries configuration information indicating configuring a first configuration parameter set and a second configuration parameter set; and the first-type message further carries mapping information indicating a mapping relationship between a single initial BWP and a configured second configuration parameter set.

In some examples of the present disclosure, the first-type message may be the first-type message in above examples.

For example, the first-type message includes a system message. Here, the system message may be any system information block, which may be, but is not limited to, SIB1, SIB2, SIB11 or SIB12.

For example, the first-type message includes a system information block SIB17 or a system information block SIBX.

For example, IEs of the first configuration parameter set include: an indication information duration or at least part of IEs in a TRS resource set, and IEs of the second configuration parameter set include: at least one IE in the TRS resource set that is not the IEs in the first configuration parameter set; or, the IEs of the first configuration parameter set include: an indication information duration, and the IEs of the second configuration parameter set include: at least one of the IEs in the TRS resource set.

In some examples, step S101 that the configuration information is received includes: a second-type message is received, where the second-type message carries configuration information indicating configuring the second configuration parameter set.

An example of the present disclosure provides a method for processing information, which is performed by first-type UE and includes: a second-type message is received, where the second-type message carries configuration information indicating configuring a second configuration parameter set.

In some examples of the present disclosure, the second-type message may be the second-type message in above examples.

For example, the second-type message includes: a PDCCH configuration message (PDCCH-ConfigCommon).

It is to be noted that, those skilled in the art can understand that the method provided by the example of the present disclosure can be performed separately, or performed with some methods in the example of the present disclosure or some methods in the related art.

An example of the present disclosure provides a method for processing information, which is performed by first-type UE and includes: in a case where both a received first-type message and a received second-type message carry configuration information indicating configuring a second configuration parameter set on an initial BWP, it is determined to use the initial BWP carried in the second-type message;
or, in a case where the received second-type message does not carry the configuration information indicating configuring the second configuration parameter set on the initial BWP, it is determined to use the configuration information indicating configuring the second configuration parameter set on the initial BWP carried in the first-type message.

Here, if a second configuration parameter set of a single initial BWP is transmitted in the first-type message and the second-type message, then the second configuration parameter set of the single initial BWP carried in the second-type message covers the second configuration parameter set of the single initial BWP carried in the first-type message. At the moment, the first-type UE determines that the second configuration parameter set for the single initial BWP in the second-type message is valid.

Here, if the second configuration parameter set of the single initial BWP is in the first-type message and the second configuration parameter set of the single initial BWP is configured in the second-type message but not issued, then the second configuration parameter set of the single initial BWP carried in the first-type message is valid.

In some examples, the initial BWP includes: a first initial BWP.

The method includes: indication information of at least one first initial BWP is received, where the indication information is configured to indicate an availability state of a configuration parameter set configured on the first initial BWP.

An example of the present disclosure provides a method for processing information, which is performed by first-type UE and includes: indication information of at least one first initial BWP is received, where the indication information is configured to indicate an availability state of a configuration parameter set configured on the first initial BWP.

In some examples, the step that the indication information of the at least one first initial BWP is received includes at least one of:
a PEI of the first initial BWP is received, where the PEI includes the indication information; or
paging DCI of the first initial BWP is received, where the paging DCI includes the indication information.

In some examples, an initial BWP further includes: a second initial BWP. The indication information is further configured to indicate an availability state of a configuration parameter set configured on the second initial BWP.

An example of the present disclosure provides a method for processing information, which is performed by first-type UE and includes: indication information of at least one first initial BWP is received, where the indication information is configured to indicate an availability state of a configuration parameter set configured on the first initial BWP and to indicate an availability state of a configuration parameter set configured on a second initial BWP.

In some examples, the availability state includes at least one of: an available state; or an unavailable state.

As an example, if a certain BWP is not configured with a parameter set, then the availability state is unavailable.

An example of the present disclosure provides a method for processing information, which is performed by first-type UE and includes: in a case where the indication information indicates that a configuration parameter set configured on a first initial BWP is in an unavailable state, it is determined to fall back to a synchronization signal block/PBCH (SSB) synchronization mode for performing synchronization;
or, in a case where the first-type UE needs to use a reference signal on a second initial BWP, first, hopping to the second initial BWP having the reference signal is carried out for performing synchronization or measurement, and then it returns to an originally-used first initial BWP.

In some examples, step S101 that the configuration information is received includes: a system information block is received, where different segments of the system information block or different system messages carry configuration information indicating configuration parameter sets configured on different initial BWPs. Here, the system message may be the system information block.

An example of the present disclosure provides a method for processing information, which is performed by first-type UE and includes: a system information block is received, where different segments of the system information block or different system messages carry configuration information indicating configuration parameter sets configured on different initial BWPs.

In some examples, the initial BWPs include: a first initial BWP and a second initial BWP.

A first segment of the system information block carries configuration information of a first configuration parameter set and/or a second configuration parameter set configured on the first initial BWP, and a second segment of the system information block carries configuration information of a second configuration parameter set configured on the second initial BWP.

In some examples, the step that the system information block is received includes: based on an initial BWP that needs to be monitored by the UE, a segment corresponding to the initial BWP in the system information block or different system messages is obtained.

An example of the present disclosure provides a method for processing information, which is performed by first-type UE and includes: based on an initial BWP that needs to be monitored by the UE, a segment corresponding to the initial BWP in the system information block or different system messages is obtained. As such, in the example of the present disclosure, a corresponding segment of the system information block may be obtained based on the initial BWP that needs to be monitored, and thus the overhead of signaling interactions may be reduced, and then the purposes of power saving and/or power consumption lowering are achieved.

An example of the present disclosure provides a method for processing information, which is performed by first-type UE and includes: all segments of a system information block are received. As such, in the example of the present disclosure, all the segments of the system information block may also be obtained so as to store more information, such as a configuration parameter set configured on at least one initial BWP.

An example of the present disclosure provides a method for processing information, which is performed by first-type UE and includes: in a case where a segment of a system information block corresponding to the initial BWP is received, it is determined to bring configuration information carried on the segment into effect. Here, when the system information block having the segment corresponding to the configuration parameter set of a reference signal is obtained, is it considered that configuration change of the reference signal comes into effect.

The above implementations may specifically refer to the description on the network device side, and will not be repeated here.

It is to be noted that, those skilled in the art can understand that the method provided by the example of the present disclosure can be performed separately, or performed with some methods in the example of the present disclosure or some methods in the related art.

In order to further explain any example of the present disclosure, a specific example is provided below.

An example of the present disclosure provides a method for processing information, which is performed by a communication device. The communication device includes a network device and first-type UE. The information processing method includes the following steps:
step S1101: configuration information of a reference signal on at least one initial BWP of the first-type UE is determined by the network device, where the configuration information indicates a configuration of a configuration parameter set; and the configuration parameter set includes: a set of at least one IE configured to indicate a resource set of the reference signal.

In an alternative example, the first-type UE may be R18 Redcap UE. Here, the configuration information is used by the first-type UE in an RRC unconnected state.

In an alternative example, at least one of the following is included, but is not limited to: a first configuration parameter set, supporting sharing by a plurality of initial BWPs; or a second configuration parameter set, supporting use by a single initial BWP.

For example, IEs of the first configuration parameter set include at least one of: an indication information duration (validityDuration); power control offset (powerControlOffsetSS); or at least one IE in TRS-ResourceSet-r17.

For example, IEs of the second configuration parameter set include at least one of: a starting resource block (startingRB); the number of resource blocks (nrofRBs); or at least one IE in TRS-ResourceSet-r17.

Here, a number of bits of at least part of IEs in the configuration parameter set of the first-type UE is different from a number of bits of corresponding IEs in a configuration parameter set of second-type UE.

Step S1102: the configuration information is transmitted to the first-type UE by the network device, where step S1102 includes step S1102A, step S1102B, step S1102C and step S1102D.

Step S1102A: a first-type message is transmitted to the first-type UE by the network device, where the first-type message carries configuration information indicating configuring the first configuration parameter set.

In an alternative example, the first-type message may be SIB17 or SIBX.
step S1102B: a first-type message is transmitted to the first-type UE by the network device, where the first-type message carries configuration information indicating configuring the second configuration parameter set; and the first-type message further carries mapping information indicating a mapping relationship between a single initial BWP and a configured second configuration parameter set.

For example, a first-type message is transmitted, where the first-type message carries configuration information indicating configuring the first configuration parameter set and the second configuration parameter set, and the first-type message further carries mapping information indicating a mapping relationship between a single initial BWP and a configured second configuration parameter set. The IEs of the first configuration parameter set include the indication information duration or at least part of IEs in TRS-ResourceSet-r17, and the IEs of the second configuration parameter set include at least one IE in TRS-ResourceSet-r17 that is not IEs in the first configuration parameter set.

For example, the first-type message is transmitted, where the first-type message carries the configuration information indicating configuring the first configuration parameter set and the second configuration parameter set, and the first-type message further carries the mapping information indicating the mapping relationship between a single initial BWP and a configured second configuration parameter set. The IEs of the first configuration parameter set include the indication information duration, and the IEs of the second configuration parameter set include at least one IE in TRS-ResourceSet-r17.

Step S1102C: a second-type message is transmitted to the first-type UE by the network device, where the second-type message carries configuration information indicating configuring the second configuration parameter set.

In an alternative example, the second-type message includes: a PDCCH configuration message.

Here, a configuration parameter set of each initial BWP may be configured and issued in the first-type message, or configured and issued in the second-type message. If the configuration parameter set of the initial BWP is configured and issued in the second-type message, then the configuration parameter set of the initial BWP configured and issued in the second-type message is valid.

Here, the configuration parameter set of each initial BWP may be configured and issued in the first-type message, or configured and issued in the second-type message. If the configuration parameter set of the initial BWP is not issued in the second-type message, then the configuration parameter set of the initial BWP configured and issued in the first-type message is valid.

Step S1102D: a system information block is transmitted to the first-type UE by the network device, where different segments of the system information block carry configuration information indicating configuration parameter sets configured on different initial BWPs.

For example, the initial BWPs configured by the network device for the first-type UE include: a first initial BWP and a second initial BWP. SIB-X is transmitted to the first-type UE by the network device, where a first segment of SIB-X carries configuration information of a first configuration parameter set and/or a second configuration parameter set configured on the first initial BWP, and a second segment of SIB-X carries configuration information of a second configuration parameter set configured on the second initial BWP.

Step S1103: indication information of the initial BWPs is transmitted to the first-type UE by the network device, where the indication information indicates an availability state of configuration parameter sets configured on the initial BWPs.

In an alternative example, step S1103 is prior to step S1102.

In an alternative example, PEIs of the initial BWPs are transmitted by the network device, where the PEIs include indication information; and/or, paging DCI of the initial BWPs is transmitted by the network device, where the paging DCI includes the indication information.

In an alternative example, indication information of at least one first initial BWP is transmitted to the first-type UE by the network device, and the indication information is configured to indicate an availability state of a configuration parameter set configured on the first initial BWP and to indicate an availability state of a configuration parameter set configured on the second initial BWP.

In an alternative example, after step S1103, step S1104 is further included, where step S1104 includes step S1104A or step S1104B.

Step S1104A: in a case where the indication information indicates that the configuration parameter set configured on the first initial BWP is in an unavailable state, the first-type UE determines to fall back to a synchronization signal block/PBCH (SSB) synchronization mode for performing synchronization.

Step S1104B: in a case where the first-type UE needs to use a reference signal on a second initial BWP, the first-type UE first hops to the second initial BWP having the reference signal for performing synchronization or measurement, and then returns to an originally-used first initial BWP.

In an alternative example, after step S1102D, the method further includes:
step S1105: based on an initial BWP that need to be monitored by the UE, a segment corresponding to the initial BWP in the system information block is obtained.

In an alternative example, step S1105 may also be that: all segments of the system information block are received.

In an alternative example, after step S1105, the method further includes:
step S1106: in a case where receiving the segment corresponding to the initial BWP in the system information block, the first-type UE determines to bring the configuration information carried on the segment into effect.

For example, if SIB scheduling indicates that a corresponding segment of SIB-X has changed, the UE (such as the first-type UE) considers its configured TRSs as unavailable until the UE receives associated 11 (Lay1)-based availability indications.

That is, if SIB scheduling indicates that the corresponding segment(s) of SIB-X has changed, the UE considers its configured TRS(s) as unavailable until it receives the associated L1-based availability indication(s).

It is to be noted that, those skilled in the art can understand that the method provided by the example of the present disclosure can be performed separately, or performed with some methods in the example of the present disclosure or some methods in the related art.

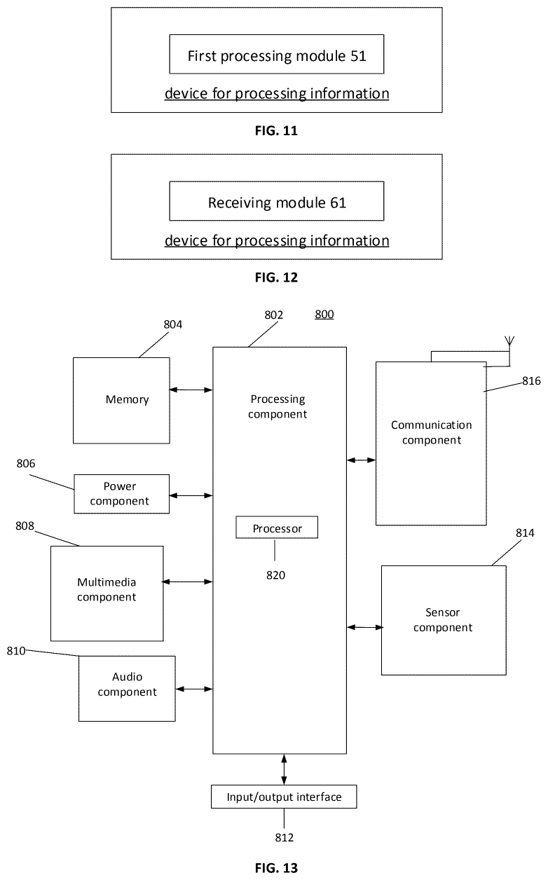

As shown in FIG. 11, an example of the present disclosure provides a device for processing information, including:
a first processing module 51, configured to determine configuration information of a reference signal on at least one initial BWP of first-type UE, where the configuration information indicates a configuration of a configuration parameter set; and the configuration parameter set includes: a set of at least one IE configured to indicate a resource set of the reference signal.

The device for processing information provided by the example of the present disclosure may be applied to a network device.

In some examples, the reference signal includes at least one of: a TRS or a CSI-RS.

The configuration parameter set includes, but is not limited to, at least one of:
a first configuration parameter set, supporting sharing by a plurality of initial BWPs; or
a second configuration parameter set, supporting use by a single initial BWP.

In one example, IEs in the first configuration parameter set include at least one of:
an indication information duration (validityDuration);
power control offset (powerControlOffsetSS); or
at least one IE in a TRS resource set.

Here, the indication information duration (validityDuration) is configured to indicate an availability duration of the configuration information or the first configuration parameter set.

In one example, IEs in the second configuration parameter set include at least one of:
a starting resource block (startingRB);
the number of resource blocks (nrofRBs); or
at least one IE in a TRS resource set.

Here, the TRS resource set may be: TRS-ResourceSet-r17, or, the TRS resource set may be any implementable TRS resource set or a newly-defined TRS resource set. Here, TRS-ResourceSet-r17 may be split into a first configuration parameter set and a second configuration parameter set.

In one example, the TRS resource set includes IEs of at least one of: power control offset (powerControlOffsetSS), a first OFDM symbol in a time domain (firstOFDMSymbolInTimeDomain), a starting resource block (startingRB), the number of resource blocks (nrofRBs), a synchronization signal index (ssb-Index), a periodicity and offset (periodicityAndOffset), frequency domain resource position allocation (frequencyDomainAllocation), an indicating bit identification (indBitID), or the number of resources (nrofResources).

Here, the resource set may be a set of one or more IEs in any above example.

An example of the present disclosure provides a device for processing information, including: a transmission module, configured to transmit configuration information.

In some examples, a number of bits of at least part of IEs in a configuration parameter set of first-type UE is different from a number of bits of corresponding IEs in a configuration parameter set of second-type UE.

An example of the present disclosure provides a device for processing information, including: a transmission module, configured to transmit a first-type message, where the first-type message carries configuration information indicating configuring a first configuration parameter set.

An example of the present disclosure provides a device for processing information, including: a transmission module, configured to transmit a first-type message, where the first-type message carries configuration information indicating configuring a first configuration parameter set and a second configuration parameter set; and the first-type message further carries mapping information indicating a mapping relationship between a single initial BWP and a configured second configuration parameter set.

In some examples, the first-type message includes a system information block, where the system information block includes SIB17 or SIBX.

An example of the present disclosure provides a device for processing information, including: a transmission module, configured to transmit a second-type message, where the second-type message carries configuration information indicating configuring a second configuration parameter set.

In some examples, the second-type message includes: a PDCCH configuration message.

In some examples, initial BWPs include: a first initial BWP.

An example of the present disclosure provides a device for processing information, including: a transmission module, configured to transmit indication information of at least one first initial BWP, where the indication information is configured to indicate an availability state of a configuration parameter set configured on the first initial BWP.

In yet some examples, the initial BWPs further include: a second initial BWP. The indication information is further configured to indicate an availability state of a configuration parameter set configured on the second initial BWP.

An example of the present disclosure provides a device for processing information, including: a transmission module, configured to transmit indication information of a first initial BWP, where the indication information is configured to indicate an availability state of a configuration parameter set configured on the first initial BWP and to indicate an availability state of a configuration parameter set configured on a second initial BWP.

An example of the present disclosure provides a device for processing information device for processing information, including: a transmission module, configured to perform at least one of:
transmitting a PEI of a first initial BWP, where the PEI includes indication information; or
transmitting paging DCI of the first initial BWP, where the paging DCI includes the indication information.

In some examples, an availability state includes at least one of: an available state; or an unavailable state.

An example of the present disclosure provides a device for processing information, including: a transmission module, configured to transmit a system information block, where different segments of the system information block carry configuration information indicating configuration parameter sets configured on different initial BWPs.

In some examples, the initial BWPs include: a first initial BWP and a second initial BWP, where a first segment of the system information block carries configuration information of a first configuration parameter set and/or a second configuration parameter set configured on the first initial BWP, and a second segment of the system information block carries configuration information of a second configuration parameter set configured on the second initial BWP.

As shown in FIG. 12, an example of the present disclosure provides a device for processing information, including:

a receiving module 61, configured to receive configuration information, where the configuration information is configured to indicate a configuration of a configuration parameter set of a reference signal on at least one BWP of first-type UE; and the configuration parameter set includes: a set of at least one IE configured to indicate a resource set of the reference signal.

The device for processing information provided by the example of the present disclosure may be applied to first-type UE.

In some examples, the reference signal includes at least one of: a TRS or a CSI-RS.

The configuration parameter set includes, but is not limited to, at least one of:
a first configuration parameter set, supporting sharing by a plurality of initial BWPs; or
a second configuration parameter set, supporting use by a single initial BWP.

In one example, IEs in the first configuration parameter set include at least one of:
an indication information duration (validityDuration);
power control offset (powerControlOffsetSS); or
at least one IE in a TRS resource set.

Here, the indication information duration (validityDuration) is configured to indicate an availability duration of the configuration information or the first configuration parameter set.

In one example, IEs in the second configuration parameter set include at least one of:
a starting resource block (startingRB);
the number of resource blocks (nrofRBs); or
at least one IE in a TRS resource set.

Here, the TRS resource set may be: TRS-ResourceSet-r17, or, the TRS resource set may be any implementable TRS resource set or a newly-defined TRS resource set. Here, TRS-ResourceSet-r17 may be split into a first configuration parameter set and a second configuration parameter set.

In one example, the TRS resource set includes IEs of at least one of: power control offset (powerControlOffsetSS), a first OFDM symbol in a time domain (firstOFDMSymbolInTimeDomain), a starting resource block (startingRB), the number of resource blocks (nrofRBs), a synchronization signal index (ssb-Index), a periodicity and offset (periodicityAndOffset), frequency domain resource position allocation (frequencyDomainAllocation), an indicating bit identification (indBitID), or the number of resources (nrofResources).

Here, the resource set may be a set of one or more IEs in any above example.

In some examples, a number of bits of at least part of IEs in a configuration parameter set of the first-type UE is different from a number of bits of corresponding IEs in a configuration parameter set of second-type UE.

An example of the present disclosure provides a device for processing information, including: a receiving module 61, configured to receive a first-type message, where the first-type message carries configuration information indicating configuring a first configuration parameter set.

An example of the present disclosure provides a device for processing information, including: a receiving module 61, configured to receive a first-type message, where the first-type message carries configuration information indicating configuring a first configuration parameter set and a second configuration parameter set; and the first-type message further carries mapping information indicating a mapping relationship between a single initial BWP and a configured second configuration parameter set.

In some examples, the first-type message includes a system information block SIB17 or a system information block SIBX.

In some examples, IEs of the first configuration parameter set include: an indication information duration or at least part of IEs in a TRS resource set, and IEs of the second configuration parameter set include: at least one IE in the TRS resource set that is not the IEs in the first configuration parameter set; or, the IEs of the first configuration parameter set include: an indication information duration, and the IEs of the second configuration parameter set include: at least one of the IEs in the TRS resource set.

An example of the present disclosure provides a device for processing information, including: a receiving module 61, configured to receive a second-type message, where the second-type message carries configuration information indicating configuring a second configuration parameter set.

In some examples, the second-type message includes: a PDCCH configuration message.

An example of the present disclosure provides a device for processing information, including: a second processing module, configured to, in a case where both a received first-type message and a received second-type message each carry configuration information indicating configuring a second configuration parameter set on an initial BWP, determine to use configuration information indicating configuring the second configuration parameter set on the initial BWP carried in a second-type message.

An example of the present disclosure provides a device for processing information, including: a second processing module, configured to, in a case where a received second-type message does not carry configuration information indicating configuring a second configuration parameter set on an initial BWP, determine to use configuration information indicating configuring the second configuration parameter set on the initial BWP carried in a first-type message.

In some examples, the initial BWP includes: a first initial BWP.

A receiving module is configured to receive indication information of at least one first initial BWP, where the indication information is configured to indicate an availability state of a configuration parameter set configured on the first initial BWP.

An example of the present disclosure provides a device for processing information, including: a receiving module 61, configured to receive indication information of at least one first initial BWP, where the indication information is configured to indicate an availability state of a configuration parameter set configured on the first initial BWP.

In some examples, an initial BWP further includes: a second initial BWP. The indication information is further configured to indicate an availability state of a configuration parameter set configured on the second initial BWP.

An example of the present disclosure provides a device for processing information, including: a receiving module 61, configured to include at least one of:
receiving a PEI of a first initial BWP, where the PEI includes indication information; or
receiving paging DCI of the first initial BWP, where the paging DCI includes the indication information.

In some examples, an availability state includes at least one of: an available state; or an unavailable state.

An example of the present disclosure provides a device for processing information, including: a second processing module, configured to, in a case where the indication information indicates that a configuration parameter set configured on a first initial BWP is in an unavailable state, determine to fall back to a synchronization signal block/PBCH (SSB) synchronization mode for performing synchronization.

An example of the present disclosure provides a device for processing information, including: a second processing module, configured to, in a case where the first-type UE needs to use a reference signal on a second initial BWP, first hop to the second initial BWP with a reference signal for performing synchronization or measurement, and then return to an originally-used first initial BWP.

An example of the present disclosure provides a device for processing information, including: a receiving module 61, configured to receive a system information block, where different segments of the system information block carry configuration information indicating configuration parameter sets configured on different initial BWPs.

In some examples, the initial BWPs include: a first initial BWP and a second initial BWP.

A first segment of the system information block carries configuration information of a first configuration parameter set and/or a second configuration parameter set configured on the first initial BWP, and a second segment of the system information block carries configuration information of a second configuration parameter set configured on the second initial BWP.

An example of the present disclosure provides a device for processing information, including: a receiving module 61, configured to obtain, based on an initial BWP that needs to be monitored by UE, a segment corresponding to the initial BWP in a system information block.

An example of the present disclosure provides a device for processing information, including: a second processing module, configured to determine, in a case where receiving a segment corresponding to an initial BWP in a system information block, to bring configuration information carried on the segment into effect.

It is to be noted that, those skilled in the art can understand that the device provided by the example of the present disclosure can be performed separately, or performed with some devices in the example of the present disclosure or some devices in the related art.

As for the device in the above example, the specific manner in which each module performs operations has been described in detail in the example about the method, which will not be described in detail here.

An example of the present disclosure provides a communication device, including:
a processor; and
a memory that stores processor-executable instructions; where
the processor is configured to implement, when executing the executable instructions, the method for processing information of any example of the present disclosure.

In one example, the communication device may include, but is not limited to, at least one of: a network device or first-type UE.

The processor may include storage media of various types. The storage media are non-transitory computer storage media, and can continue to memorize information stored after user equipment is powered down.

The processor may be connected with the memory via a bus and the like, and is configured to read an executable program stored on the memory, such as at least one of the methods shown in FIG. 3 to FIG. 10.

An example of the present disclosure further provides a computer storage medium. The computer storage medium stores computer-executable programs, and the executable programs, when executed by a processor, implement the method for processing information of any example of the present disclosure. For example, the method is at least one of the methods as shown in FIG. 3 to FIG. 10.

As for the device or storage medium in the above example, the specific manner in which each module performs operations has been described in detail in the example about the method, which will not be described in detail here.

FIG. 13 is a block diagram of user equipment 800 illustrated according to an example. For example, the user equipment 800 may be a mobile phone, a computer, digital broadcasting user equipment, a messaging device, a game console, a tablet device, a medical device, a fitness device, a personal digital assistant, etc.

Referring to FIG. 13, the user equipment 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls the overall operation of the user equipment 800, such as operations associated with display, telephone call, data communication, camera operations, and recording operations. The processing component 802 may include one or more processors 820 to execute instructions to complete all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the user equipment 800. Instances of these data include instructions for any application or method operating on the user equipment 800, contact data, phonebook data, messages, pictures, videos, etc. The memory 804 may be implemented by any type of volatile or nonvolatile storage device or a combination of them, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optic disk.

The power component 806 provides power for various components of the user equipment 800. The power component 806 may include a power management system, one or more power sources and other components associated with generating, managing and distributing power for the user equipment 800.

The multimedia component 808 includes a screen providing an output interface between the user equipment 800 and a user. In some examples, the screen may include a liquid crystal display (LCD) and a touch panel (TP). If the screen includes the touch panel, the screen may be implemented as a touch screen to receive an input signal from the user. The touch panel includes one or more touch sensors to sense touch, sliding and gestures on the touch panel. The touch sensor can not only sense the boundary of the touch or sliding operation, but also detect the duration and pressure related to the touch or sliding operation. In some examples, the multimedia component 808 includes a front camera and/or a rear camera. When the user equipment 800 is in an operation mode, such as a shooting mode or a video mode, the front camera and/or the rear camera can receive external multimedia data. Each front camera and rear camera can be a fixed optical lens system or have a focal length and optical zoom capability.

The audio component 810 is configured to output and/or input audio signals. For instance, the audio component 810 includes a microphone (MIC) configured to receive an external audio signal when the user equipment 800 is in the operation mode, such as a call mode, a recording mode, and a speech recognition mode. The received audio signal may be further stored in the memory 804 or transmitted via the communication component 816. In some examples, the audio component 810 also includes a speaker for outputting an audio signal.

The I/O interface 812 provides an interface between the processing component 802 and a peripheral interface module which can be a keyboard, a click wheel, a button, etc. These buttons may include but are not limited to: a home button, volume buttons, a start button and a lock button.

The sensor component 814 includes one or more sensors for providing state evaluation of various aspects of the user equipment 800. For instance, the sensor component 814 can detect an on/off state of the user equipment 800 and the relative positioning of the components, for instance, the component is a display and a keypad of the user equipment 800. The sensor component 814 can also detect the change of the position of the user equipment 800 or one component of the user equipment 800, the presence or absence of user contact with the user equipment 800, the azimuth or acceleration/deceleration of the user equipment 800, and temperature change of the user equipment 800. The sensor component 814 may include a proximity sensor configured to detect the presence of nearby objects without any physical contact. The sensor component 814 may further include an optical sensor, such as a CMOS or CCD image sensor, for use in imaging applications. In some examples, the sensor component 814 may further include an acceleration sensor, a gyroscope sensor, a magnetic sensor, a pressure sensor, or a temperature sensor.

The communication component 816 is configured to facilitate wired or wireless communication between the user equipment 800 and other devices. The user equipment 800 may access a wireless network based on a communication standard, such as WiFi, 4G or 5G, or a combination of them. In an example, the communication component 816 receives a broadcast signal or broadcast-related information from an external broadcast management system via a broadcast channel. In an example, the communication component 816 further includes a near field communication (NFC) module to facilitate short-range communication. For instance, the NFC module may be implemented based on a radio frequency identification (RFID) technology, an infrared data association (IrDA) technology, an ultra wideband (UWB) technology, a Bluetooth (BT) technology and other technologies.

In an example, the user equipment 800 may be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic elements for performing the above method.

In an example, a non-transitory computer-readable storage medium including instructions, such as the memory 804 including instructions, which can be executed by the processor 820 of the user equipment 800 to complete the above method, is also provided. For instance, the non-transitory computer-readable storage medium may be a ROM, a random access memory (RAM), a CD-ROM, a magnetic tape, a floppy disk, an optical data storage device, etc.

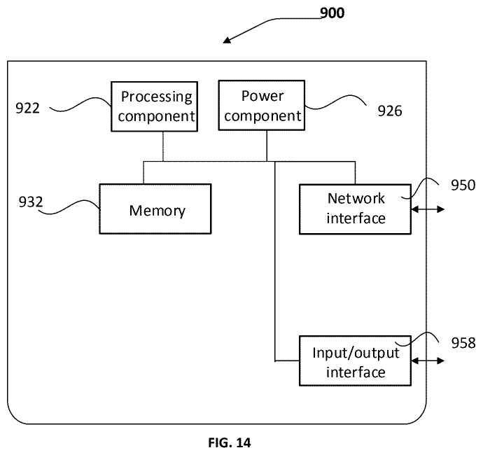

As shown in FIG. 14, an example of the present disclosure shows a structure of a base station. For instance, the base station 900 may be provided as a network side device. Referring to FIG. 14, the base station 900 includes a processing component 922, which further includes one or more processors, and a memory resource represented by a memory 932 for storing instructions, such as applications, that can be executed by the processing component 922. The applications stored in the memory 932 may include one or more modules each corresponding to a set of instructions. In addition, the processing component 922 is configured to execute instructions to execute any method applied to the base station.

The base station 900 may further include a power component 926 configured to perform power management of the base station 900, a wired or wireless network interface 950 configured to connect the base station 900 to the network, and an input/output (I/O) interface 958. The base station 900 can operate an operating system stored in the memory 932, such as Windows Server™, Mac OS X™, Unix™, Linux™, FreeBSD™, or the like.

Other implementation solutions of the present disclosure will be apparent to those skilled in the art from consideration of the specification and practice of the present disclosure here. The present disclosure is intended to cover any variations, uses, or adaptations of the present disclosure following the general principles of the present disclosure and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope of the present disclosure. It is intended that the scope of the present disclosure only be limited by the appended claims.

1. A method for processing information, performed by a network device, the method comprising:
determining configuration information of a reference signal on at least one initial bandwidth part (BWP) of first-type user equipment (UE), wherein the configuration information indicates a configuration of a configuration parameter set and the configuration parameter set comprises a set of at least one information element (IE) configured to indicate a resource set of the reference signal.

2. The method according to claim 1, wherein the reference signal comprises at least one of the following:
a tracking reference signal (TRS); or
a channel state information-reference signal (CSI-RS).

3. The method according to claim 1, further comprising:
transmitting the configuration information.

4. The method according to claim 3, wherein the configuration parameter set comprises at least one of the following:
a first configuration parameter set, supporting sharing by a plurality of initial BWPs; or
a second configuration parameter set, supporting use by a single initial BWP.

5. The method according to claim 1, wherein a number of bits of at least part of IEs in the configuration parameter set of the first-type UE is different from a number of bits of corresponding IEs in a configuration parameter set of second-type UE.

6. The method according to claim 4, wherein transmitting the configuration information comprises at least one of the following:
transmitting a first-type message, wherein the first-type message carries configuration information indicating configuring the first configuration parameter set;
transmitting a first-type message, wherein the first-type message carries configuration information indicating configuring the first configuration parameter set and the second configuration parameter set; and the first-type message further carries mapping information indicating a mapping relationship between a single initial BWP and a configured second configuration parameter set; or
transmitting a second-type message, wherein the second-type message carries configuration information indicating configuring the second configuration parameter set;
wherein the first-type message comprises a system information block and the system information block comprises SIB17 or SIBX; and
wherein the second-type message comprises a physical downlink control channel (PDCCH) configuration message.

7-10. (canceled)

11. The method according to claim 1, wherein the at least one initial BWP comprises a first initial BWP; and
the method further comprises:
transmitting indication information of at least one first initial BWP, wherein the indication information is configured to indicate an availability state of a configuration parameter set configured on the first initial BWP.

12. The method according to claim 11, wherein transmitting the indication information of the at least one first initial BWP comprises at least one of:
transmitting a paging early indication (PEI) of the first initial BWP, wherein the PEI comprises the indication information; or
transmitting paging downlink control information (DCI) of the first initial BWP, wherein the paging DCI comprises the indication information.

13. (canceled)

14. The method according to claim 4, wherein the transmitting the configuration information comprises:
transmitting a system information block, wherein different segments of the system information block carry configuration information indicating configuration parameter sets configured on different initial BWPs.

15. A method for processing information, performed by first-type user equipment (UE), the method comprising:
receiving configuration information, wherein the configuration information is configured to indicate a configuration of a configuration parameter set of a reference signal on at least one initial bandwidth part (BWP) of the first-type UE; and the configuration parameter set comprises a set of at least one information element (IE) configured to indicate a resource set of the reference signal.

16. The method according to claim 15, wherein the reference signal comprises at least one of the following:
a tracking reference signal (TRS); or
a channel state information-reference signal (CSI-RS).

17. The method according to claim 15, wherein the configuration parameter set comprises at least one of:
a first configuration parameter set, supporting sharing by a plurality of initial BWPs; or
a second configuration parameter set, supporting use by a single initial BWP.

18. The method according to claim 15, wherein a number of bits of at least part of IEs in the configuration parameter set of the first-type UE is different from a number of bits of corresponding IEs in a configuration parameter set of second-type UE.

19. The method according to claim 17, wherein receiving the configuration information comprises at least one of the following:
receiving a first-type message, wherein the first-type message carries configuration information indicating configuring the first configuration parameter set;
receiving a first-type message, wherein the first-type message carries configuration information indicating configuring the first configuration parameter set and the second configuration parameter set; and the first-type message further carries mapping information indicating a mapping relationship between a single initial BWP and a configured second configuration parameter set; or
receiving a second-type message, wherein the second-type message carries configuration information indicating configuring the second configuration parameter set;
wherein the first-type message comprises a system information block and the system information block comprises SIB17 or SIBX; and
wherein the second-type message comprises: a physical downlink control channel (PDCCH) configuration message.

20-23. (canceled)

24. The method according to claim 19, further comprising:
determining, in a case where both the received first-type message and second-type message carry configuration information indicating configuring the second configuration parameter set on the initial BWP, to use the configuration information indicating configuring the second configuration parameter set on the initial BWP carried in the second-type message;
or
determining, in a case where the received second-type message does not carry the initial BWP, to use the configuration information indicating configuring the second configuration parameter set on the initial BWP carried in the first-type message.

25. The method according to claim 15, wherein the at least one initial BWP comprises a first initial BWP; and the method further comprises:
receiving indication information of at least one first initial BWP, wherein the indication information is configured to indicate an availability state of a configuration parameter set configured on the first initial BWP.

26. The method according to claim 25, wherein receiving the indication information of the at least one first initial BWP comprises at least one of the following:
receiving a paging early indication (PEI) of the first initial BWP, wherein the PEI comprises the indication information; or
receiving paging downlink control information (DCI) of the first initial BWP, wherein the paging DCI comprises the indication information.

27. The method according to claim 25, wherein the availability state comprises at least one of the following:
an available state; or
an unavailable state;
wherein the method further comprises:
determining, in a case where the indication information indicates that the configuration parameter set configured on the first initial BWP is in an unavailable state, to fall back to a synchronization signal/PBCH block (SSB) synchronization mode for performing synchronization; or
determining, in a case where the first-type UE needs to use a reference signal on a second initial BWP, to first hop to the second initial BWP having the reference signal for performing synchronization or measurement, and then return to an originally-used first initial BWP.

28. (canceled)

29. The method according to claim 17, wherein receiving the configuration information comprises:
receiving a system information block, wherein different segments of the system information block carry configuration information indicating configuration parameter sets configured on different initial BWPs;
wherein receiving the system information block comprises:
obtaining, based on an initial BWP that needs to be monitored by the first-type UE, a segment corresponding to the initial BWP in the system information block;
wherein the method further comprises:
determining, in a case where receiving the segment corresponding to the initial BWP in the system information block, to bring the configuration information carried on the segment into effect.

30-33. (canceled)

34. A communication device, comprising:
one or more processors; and
a memory that stores processor-executable instructions; wherein
the one or more processors are collectively configured to:
receive configuration information, wherein the configuration information is configured to indicate a configuration of a configuration parameter set of a reference signal on at least one initial bandwidth part (BWP) of first-type user equipment (UE); and the configuration parameter set comprises: a set of at least one information element (IE) configured to indicate a resource set of the reference signal.

35. (canceled)
